(19) United States
(12) Patent Application Publication
(10) Pub. No.: US 2008/0300905 A1
(43) Pub. Date: Dec. 4, 2008

(54) METHOD OF PROVIDING A DIGITAL ATHLETE PROFILE

(75) Inventor: EDWARD F. KELLEY, III, ELLICOTT CITY, MD (US)

Correspondence Address: DUANE MORRIS LLP - Philadelphia;IP DEPARTMENT, 30 SOUTH 17TH STREET, PHILADELPHIA, PA, 19103-4196, US

(73) Assignee: DIGITALSPORTS, INC., Columbia, MD (US)

(21) Appl. No.: 12/043,360

(22) Filed: Mar. 6, 2008

Related U.S. Application Data
(60) Provisional application No. 60/893,327, filed on Mar. 6, 2007.

(51) Int. Cl. G06Q 99/00

(52) U.S. Cl. 705/1

(57) ABSTRACT

A method of providing a web-based sports or academic social network web page includes providing a digital athlete or academic profile portion configured to provide various athlete or academic information and providing a gallery portion having at least one of photographs or videos uploadable by a user. The athlete or academic information includes one or more of statistics, school information, contact information, athletic bio, academic information, news and events, athletic awards, and recommendations.

This nonprovisional patent application claims priority from provisional patent application Ser. No. 60/893,327, filed Mar. 6, 2007, entitled METHOD OF PROVIDING A DIGITAL ATHLETE PROFILE, which provisional application is incorporated herein by reference in its entirety.

### FIELD OF THE INVENTION

The invention is directed to a method of providing a sports-based and/or academic-based network portal with a personal expression of a youth sports, club sports athlete and/or student, and in particular a profile of their athletic and/or academic capabilities.

### BACKGROUND OF THE INVENTION

Many previous approaches to creating social networks via the World Wide Web have not been directed to youth sports, club sports or student academics. These approaches did not include any ability to display beneficial information for the athlete and/or student and advertising could not be directed to an athlete, student, fan or the like.

Accordingly, there is a need for a web portal that can provide a personal expression and social networking for the youth sports athlete, club sports athlete, or student and moreover allow for targeted advertising.

### SUMMARY OF THE INVENTION

The invention meets the foregoing need and allows for a method of providing a sports and/or social networking portal that allows for the youth sports or club sport athlete with a place for personal expression within the sports niche or a student a similar place for personal expression.

Moreover, the invention is directed to a social networking system that is sports and/or student-activity specific. Accordingly, the invention may encompass content based on kids playing sports from their first sports experiences through high school sports. These sports include high school sports, youth sports, club sports, and/or other sports organizations whose participants may include ages six through high school age athletes.

Users of the system may be provided with various web-based tools to generate and create their personal expression. These tools may include various different functions including an athlete profile, activities profile and/or academic profile. Each of these tools may be described as a Digital Athlete/Activities/Academic Profile or DAP. The DAP is a multi task tool that may allow young students and/or student athletes to present their academic, athletic and other accomplishments via a fun, creative and dynamic tool that may allow for multi media presentations.

The DAP tool may allow photographs, music, videos, statistical information, academic recommendations, awards, and/or other distinctive records of young athletes and/or students. The DAP also provides the students and/or student athletes with organizational and personal management tools. These may include online interactive two-way calendar systems that synchronize with parents' schedules. Moreover, these schedules may also synchronize with other young students and student athletes living in the same home. Synchronization of the schedules allows parents and/or students to better deal with the often chaotic lifestyle that plagues the young students in school activities as well as student athletic activities in his or her family.

The DAP also may serve as a one-stop entertainment source. The DAP may have other features integrated such as a sports and activity specific information source such as RSS (really simple syndication).

The DAP may allow for the display of personalized music and portal interface, photographs and videos of the student athlete's sports life, access and a links to other athletes DAPs, and the student athletes' teams and activities websites. Moreover, the DAP may provide a link to other high school and youth sports websites.

The users of the DAP may be able to communicate by using the website provided text messaging, email and/or instant messaging functions. In addition, the DAP may provide powerful search capabilities to allow the student and/or student athlete find other students and student athletes by using different filters such as competition level, school, common interests, activities, sports, and the like. The DAP may be accessible by college recruiters and admission officers seeking student athletes and/or well-rounded students engaged in extracurricular activities.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows an upper portion of a sports social networking portal constructed according to the principles of the invention;

FIG. 2 shows a mid-portion of a sports social networking portal constructed according to the principles of the invention;

FIG. 3 shows a lower portion of a sports social networking portal constructed according to the principles of the invention;

FIG. 4 shows a site menu for use with the FIGS. 1 to 3 sports social networking portal; and

FIG. 5 shows the digital athlete profile for use with the sports social networking portal of FIGS. 1 to 3.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

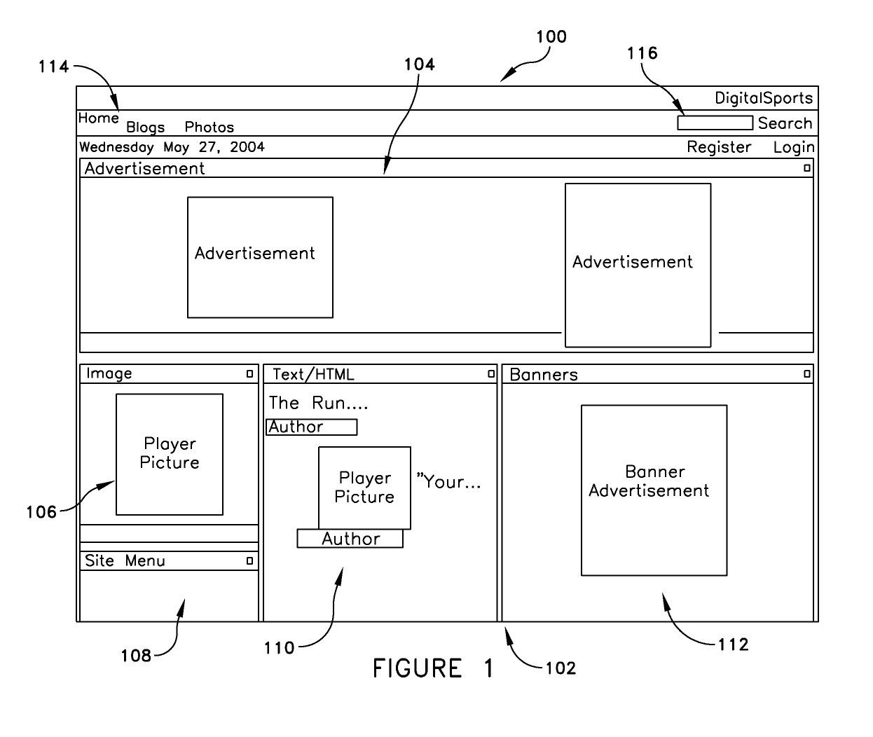

FIGS. 1, 2, and 3 show an exemplary implementation of the DAP. In particular, the DAP may include four different major areas. These areas may include facilitating interaction, entertainment, information and education, and community networking. In particular, the area of facilitating interaction may include a calendar, blogs, SMS messaging and communication, common interests group and networking, and broadcast and cable channels. More specifically, the calendar may include various calendar features for the student or student athlete. The calendar may be able to accept various dates for sports and/or academic-related activities whether entered by the student and/or student athlete, the parents, coaches and/or teachers.

The calendar feature may more specifically support the ability to make various events or calendar inserts public and private. In this regard, an individual may designate who can see the calendar events and this may allow for increased privacy. Moreover, the calendar feature allows for the insertion of group events. In particular, a team coach may designate a team and then when inserting a particular calendar event may insert it for the entire team at one time. Such integration allows for the entire team to be integrated with a single action and moreover allows for the integration of a school calendar therewith. This allows teachers and/or coaches to receive and send various alerts and messaging based on various calendar events. Moreover, the calendar provides for reminders for the various upcoming activities through the DAP interface and/or any other form of communication associated therewith. Additionally, the calendar may include various filtering capabilities. This may allow the DAP user to filter various calendar events by sports, practice, school events, personal and the like. Altogether, the calendaring capability may allow for the integration with various teams, parents, siblings and other network partners. Moreover, the calendar feature may provide a two-way communication link and may include advising features with the students, parents, and/or coaches and teachers.

The DAP may further include online journal (blog) capabilities. Members will be able to share their personal journal with other members. Moreover, the facilitate interaction section may include SMS-type messaging and communication through the use of instant messaging and/or other known forms of chat or electronic communication.

The blog feature of the DAP may, more specifically, provide for archive support. In particular, the blog feature may have the capability to archive information over time and store the same. Moreover, the blog feature may also provide commenting support. In this regard, the blog may allow for other DAP users to provide comments and notes to the active blog. Finally, the blog may also provide deletion support in order to delete subject matter that is no longer desired to be part of the blog.

Additionally, the DAP may allow for the generation or creation of common interest groups and networking. In particular, a student and/or student athlete may be able to create or join a common interest group and network with the various individuals that are part of or that join this group. Finally, the facilitate interaction portion may allow for broadcast or cable channel information to be sent to various DAPs and/or received by various DAPs. Videos may be streamed through the Digital Sports infrastructure that could be seen by all DAP members.

The DAP may further include the ability to provide entertainment. In particular, the DAP may include the ability to generate multimedia presentations. The multimedia presentations may include photographs, music and/or videos. The photographs, music and the videos may be of the student and/or student athlete or may include some of the various school functions or sports functions related therewith.

Moreover, the student or student athlete may be able to customize their particular DAP portal with a particular interface or look. This can include background colors, music, wallpaper and the like. Moreover, the ability to customize the user interface gives the user the freedom to choose different user interface skins for the DAP. Moreover, the DAP tools may allow the user to position the DAP contents wherever they desire and change the contents as they desire.

The messaging capability provides a DAP user the ability to send various SMS messages and the like to other users in their network of DAPs. Moreover, the SMS messaging allows for DAP users to send invites to other DAP users electronically.

The multimedia portion of the DAP provides for the display and upload of various photographs and videos. In particular, the multimedia portion of the DAP provides a capability to upload and display a photo gallery with album-type support. Similarly, the multimedia portion of the DAP provides a video gallery capability allowing videos to be uploaded and displayed again with album-type support. Additionally, the multimedia portion of the DAP allows for control of comments with respect to the various photographic images and/or videos. Users of the DAP may allow for various images and videos to be rated with respect to how well they like or dislike the various photographs and/or images. Finally, the multimedia portion of the DAP may allow for images and/or videos to be imported from the main Digital Sports portal into the personal DAP of the student or student athlete.

Another feature of the DAP is to inform and educate the users. In particular, the DAP may allow for the collection, upload and display of sports news, sports statistics, various sports articles and other educational-type features for display on the DAP. Moreover, the DAP may allow for RSS-type information subscriptions for displaying various RSS-type media content. The RSS information subscription information may allow users to subscribe to content both internal to the DAP system and also external to the DAP such as news websites and the like.

Moreover, the DAP may allow for personalized or related links to be added to the DAP that are directed to a particular area of interest of the user. Moreover, the DAP is contemplated to include an HTML wysiwyg-type editor. In particular, the HTML editor may allow a DAP user to design and generate a web page using straightforward-type editing actions.

The DAP may also include various other types of sources of information including FAQs (frequently asked questions), a knowledge base, and announcements section. Accordingly, the DAP user may create, add or access each of these type contents to enhance enjoyment of their personal DAP or other DAPs. The DAP FAQs and knowledge base may provide a central area where athletes may view answers to questions or the knowledge base for a particular sports and/or academic-related subject. Additionally, it may provide the ability for a posting to the knowledge base. Moreover, the DAP may allow online resumes, alumni services, and recruiting tools.

The online resume of the DAP may allow for athletes to maintain their resume for college and the like. The resume may be based on multiple resume templates that may be available through the DAP system. Moreover, the alumni services may allow alumni to maintain their DAP and coordinate their activities through the system. The alumni service may include various online directory services.

The DAP also may provide college recruiters with various recruiting tools. In particular, a recruiting tools section may provide recruiters with tools to search and choose for the right candidate. In particular, a recruiter may able to search using various search criteria based on statistics, academic information, geographic considerations, and the like.

The DAP may further include generic search capabilities. In particular, a search may be allowed from a public website as well as from the DAP portal. The search within the DAP may allow for filters and/or categories to enhance the search. Moreover, the DAP system may allow for the support of keyword searches.

The DAP system may allow networking capabilities with other athletes and/or students' DAP. In this regard, users may be able to view other DAPs within their network or their friends in one single place. Moreover, users may be able to communicate via alerts and SMS-type messages within their network.

An additional feature that may be used with the DAP is the control and monitoring feature. In particular, the DAPs may include personal password assignments and the content may be protected with these passwords. In this regard, a user may be able to limit access and control of their DAP based on the personal password. Moreover, the DAP system may allow for a peer reporting system. In this regard, if a user or peer of the DAP system sees any improper subject matter, they may be able to report this to a system administrator, coach, and/or teacher for control and/or removal thereof. Additionally, coaches, sports administrators and others may have access to all of the DAPs with a special password in order to control and monitor content thereof. Finally, parents may be able to control content through special parental control features to ensure that the students or student athletes have a limited and controlled content as directed by their parents.

The DAP may also allow for other entertaining-type network capabilities including favorite DAP pages and/or most visited-type features. Accordingly, the DAP system may allow for voting on what is the favorite DAP or may allow for a counting capability to count the number of web page hits to determine the most visited DAP.

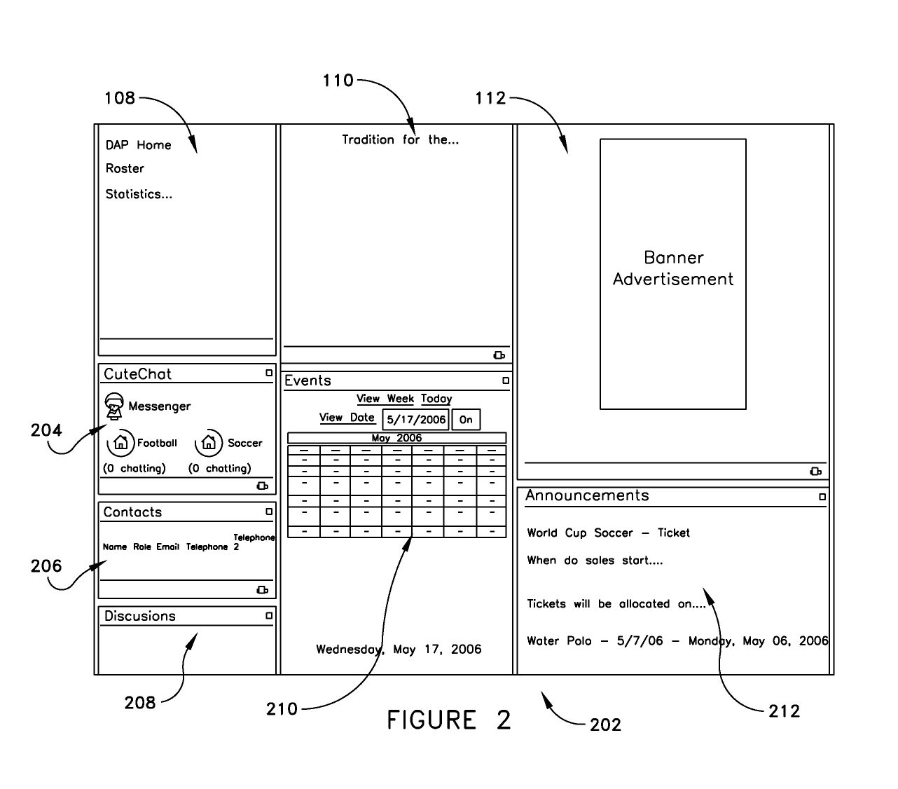

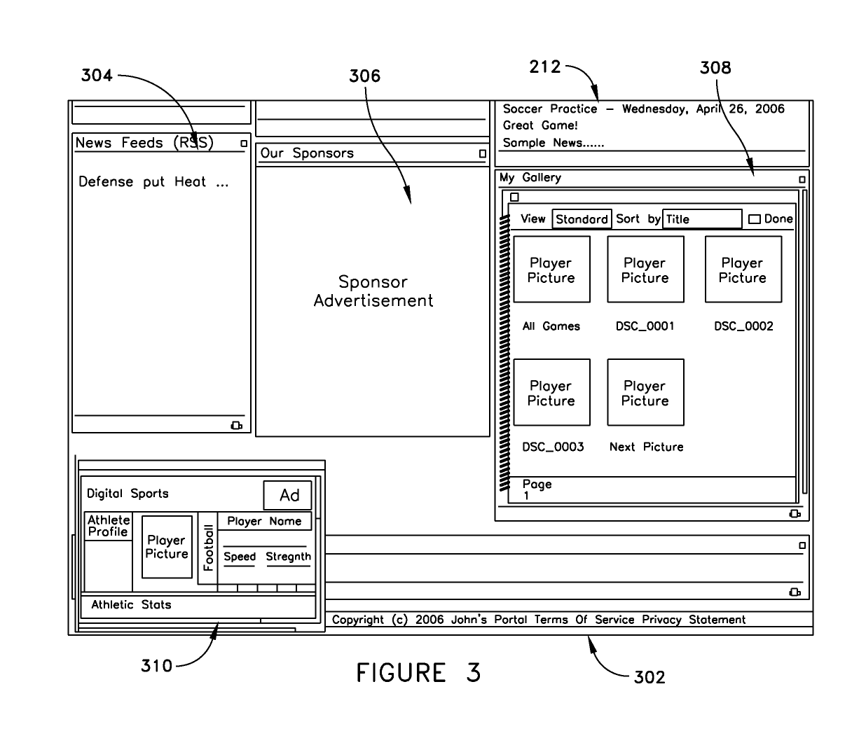

FIG. 1 shows an exemplary sports portal based on the above. In particular, a sports social networking portal 100 that includes an upper portal portion 102. The portal may also be referred to a vortol (vertical portal). More specifically, the sports social networking portal 100 may be implemented as an html-type web page or the like. The sports social networking portal 100 may include the upper portion 102 as shown in FIG. 1 that may be connected to a mid-portal portion 202 shown in FIG. 2, that may be connected to a lower portal portion 302 shown in FIG. 3. Accordingly, the FIG. 1, FIG. 2, and FIG. 3 portions together form a web page that may form the sports social networking portal 100 web page. Of course these may be separate pages, may operate together as shown, or take any other form known in the art.

As shown in FIG. 1, the sports social networking portal 100 may include the upper portal portion 102. The upper portal portion 102 may include various advertisements 104. These advertisements 104 may be based on advertisement modules that are known in the art. These advertisements may be focused directly on the type of sport, age group or the like that is specific to this sport's social networking portal. Further, the upper portal portion 102 may include an image of the player 106 of this specific web page. In this regard, the player may be able to upload to his or her own sports social networking portal 100 an image that may be included on this web page. Further, the upper portal portion 102 of the sports social networking portal 100 may include a site menu 108 shown partially in both FIG. 1 and FIG. 2. The sports social networking portal 100 may further include various text-based stories 110 as shown in FIG. 1 and FIG. 2. The portal 100 may also include navigation buttons 114 and search capability with a search input portion 116. Finally, FIG. 1 additionally shows the ability to display banner advertisements 112 as shown in FIG. 1 and continued in FIG. 2.

FIG. 2 shows a mid-portal portion 202 of the sports social networking portal 100. In particular, FIG. 2 shows continuations of the site menu 108, the text-based stories 110 and the banner advertisements 112. Additionally, the mid-portal portion 202 of the sports social networking portal 100 may include a chat section 204, a contacts section 206, a discussions section 208, an events calendar 210, and an announcements section 212.

FIG. 3 shows the lower portal portion of 302 of the sports social networking portal 100. In particular, the lower portal portion 302 may include a news feeds section 304, a sponsor advertisement section 306, a my gallery section 308 and a My DAP (Digital Athlete Profile) section 310.

Accordingly, the sports social networking portal 100 may be divided into three different sections or may be one continuous section. Additionally, the particular layout shown in FIGS. 1 to 3 is merely exemplary. The various sections and portions of the sports social networking portal shown in FIGS. 1 to 3 can take any form and can be implemented in any known way. Moreover, the sports social networking portal does not need to include each and every section as described in conjunction with the exemplary embodiment of FIGS. 1 to 3. The portal may include less or additional features or portions

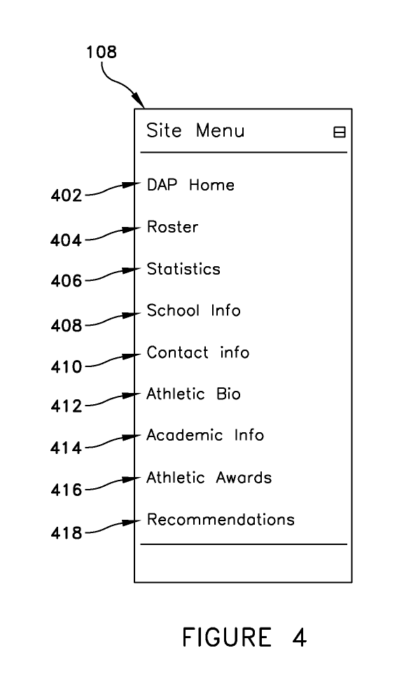

FIG. 4 shows the site menu 108. In particular, the site menu 108 may include various hyperlinks to portions of the sports social networking portal 100. In particular, hyperlink 402 may direct a website user to the digital athlete profile home. In other words, the user may select this link and it may take the user to the DAP home. The roster 404 link may take a web user to the roster of the various teams that are associated with the player of the sports social networking portal 100. Hyperlink 406 may link the website user to the statistics of the school, team, and/or player associated with the sports social networking portal 100. Contact information may be obtained by hyperlink 410. The contact information may be based on the school, team, or player associated with the sports social networking portal 100. The athlete's biography may be obtained by clicking on the athlete bio 412 of the site menu 108. The athlete bio 412 may provide various information with respect to the athlete. The academic info (information) link 414 may provide academic information regarding the player. Hyperlink 416 may direct a user to the athlete's awards, school's awards, and/or team's awards. Finally, the recommendations hyperlink 418 of the site menu 108 may provide a user with various sports or academic-based recommendations for the student athlete.

The text-based story section 110 shown in FIG. 1 may be provided by a user of the sports social networking portal 100. In particular, a user may be able to upload pictures and/or text to provide a story-based and/or interest-based feature for the sports social networking portal 100.

FIG. 2 shows the events calendar section 210 of the sports social networking portal 100. In particular, the events calendar 210 has the ability to allow entry of information regarding practice schedules, team schedules, game schedules and the like. The events calendar 210 may have the ability to allow a coach to enter calendar information and allow it to be migrated to each athlete's particular event calendar 210. Moreover, a parent may be able to enter information into the events calendar 210. A parent with multiple children participating in sports may be able to coordinate the various calendars of their children in order to coordinate the various sports schedules. This may allow a parent to work with various schedule conflicts.

FIG. 2, as noted above, shows the chat feature 204 of the sports social networking portal 100. In particular, the chat feature 204 allows the student athlete to chat with fellow athletes, coaches, parents and the like regarding various needs, reminders, etc. Moreover, parents may be able to chat with coaches and players to provide reminders, praise, and the like. Accordingly, both the events calendar 210 and the chat feature 204 may allow two-way communication between parents, coaches and athletes.

The contact feature 206 of the sports social networking portal 100 may allow a parent, coach, and/or athlete to add contact information regarding the parents, coaches, and/or athletes. This information may include name, position, email, telephone numbers or the like.

The discussions feature 208 may allow coaches, parents, and athletes to start and/or engage in various discussions in sports-related matters. In this regard, both coaches and athletic directors may have access to the sports social networking portal 100 to prevent inappropriate use. Moreover, the discussions portion 208 may allow for communication with other invited student athletes. In this regard, the content and the audience (limited access) may be limited to one degree or another as is known in the art.

The student athlete may able to select various sports websites to provide a RSS type (Really Simple Syndication—(file format) a form of web syndication used by news websites and weblogs) of news feed to the news feeds portion 304. In this way, the student athlete's favorites teams or favorite news journals may be provided on his or hers own personalized sports social networking portal 100 web page.

The announcement section 212 may include various different coach, parent, advertisement-type announcements. For example, ticket sales on other sports-related type of announcements.

The my gallery portion 308 may provide a way in which the student athlete may upload various photographs and/or videos for viewing on the website of the sports social networking portal.

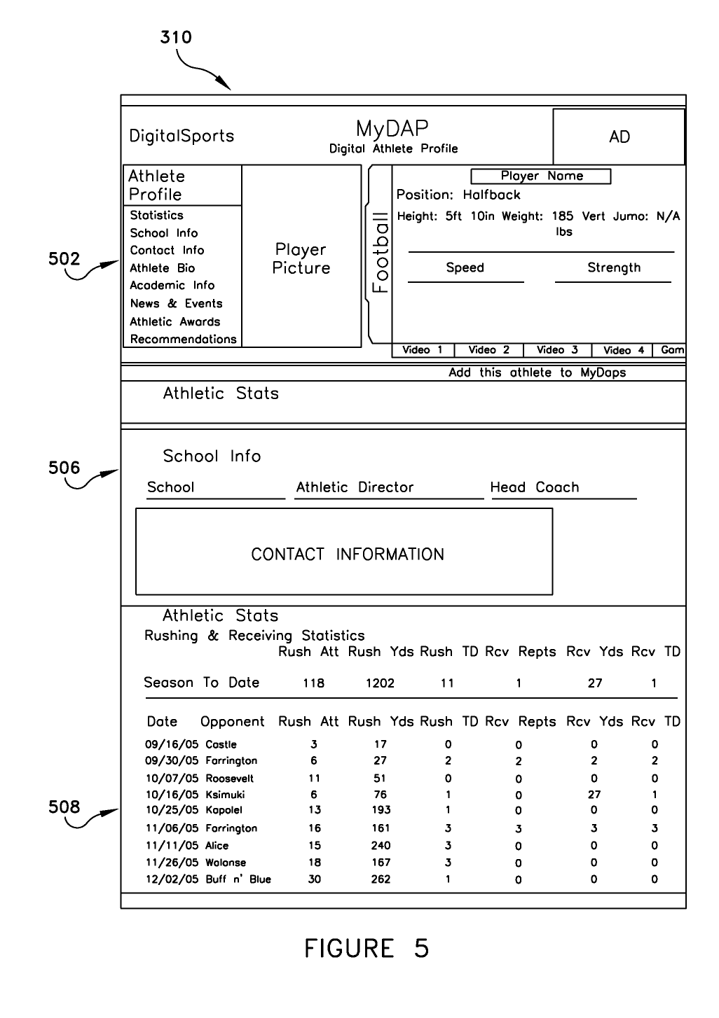

FIG. 5 shows the digital athlete profile section 310. In particular, the digital athlete profile section 310 may include a separate scrollable window within the sports social networking portal 100. Alternatively, the digital athlete profile 310 may be a separate web page or may be included in the web page of the athlete in the sports social networking portal 100. The digital athlete profile shown in FIG. 5 may include an uploaded photograph of the student athlete, the student athlete's name and various sports-based criteria including height, weight, vertical jump, sports position, speed, strength and the like. Moreover, the digital athlete profile section 310 may include one or more of statistics of the athlete, school information on the athlete, contact information of the athlete, the athlete's bio, academic information of the student athlete, news and events of the athlete, the athlete's awards, and recommendations for the athlete in section 502. Moreover, the digital athlete profile 310 may include the ability to upload various videos and game highlights 504. These highlights can include photographs (including photos, video highlights, game tapes, and the like) and also other various sports highlights for viewing by a user. The information that is provided to the digital athlete profile 310 may be gathered by various, coaches, athletic directors, fans, player, interns and other people who are willing to accumulate the information (i.e., statistics, video, digital pictures, etc.) and upload it to the website.

The digital athlete's profile may allow college recruiters to review the player's resume including the photos, the video highlights, game tapes, statistics, academic and other extracurricular activities in order to consider the athlete for scholarships and the like. As further show in FIG. 5, the digital athlete's profile 310 may include school information as shown in section 506 and may also include various statistics in section 508 and the like.

The digital athlete profile 310 may further include the ability for the athlete to personalize this particular portion. In particular, the athlete may be able to provide or designate various backgrounds, music, sports memorabilia and the like to be associated with his or her profile 310 or “locker.”

Accordingly, the sports social networking portal 100 provides a way in which a student athlete may generate and maintain a personalized sports-based web page that may provide a way in which the student athlete can exhibit a personal expression within the sports niche or genre. Moreover, this personalized web page generated through a sports social networking portal 100 may be accessed by coaches, athletic directors, and parents to prevent inappropriate use and also by parents for the exact same reason. This personalized web page through this sports social networking portal 100 provides organizational tools for the parents and players, communication systems and tools, personal expression, recruiting access and the like.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A method of providing a web-based sports social network web page comprising:
providing a digital athlete profile portion configured to provide various athlete information; and
providing a gallery portion having at least one of photographs or videos uploadable by a user,
wherein the athlete information comprises at least one of statistics, school information, contact information, athletic bio, academic information, news and events, athletic awards, and recommendations.

2. The method according to claim 1 further comprising an advertisement portion configured to provide advertisement-based content for display on the web page.

3. The method according to claim 1 further comprising an image portion allowing the display of uploaded images on the web page.

4. The method according to claim 1 further comprising a site menu providing various navigational controls to the web page.

5. The method according to claim 1 further comprising a text-based story portion providing at least one of story or images to the web page.

6. The method according to claim 1 further comprising an advertisement banner portion for providing banner-based advertisements to the web page.

7. The method according to claim 1 further comprising a chat portion for providing two-way chat communication to the web page.

8. The method according to claim 1 further comprising a contact portion for listing at least one of a name, role, email, telephone and other contact information to the web page.

9. The method according to claim 1 further comprising a discussion portion providing discussion capability through the web page.

10. The method according to claim 1 further comprising an events calendar portion providing events calendar capabilities on the web page.

11. The method according to claim 1 further comprising an announcement portion to provide various announcement information for display on the web page.

12. The method according to claim 1 further comprising a news feed portion for providing various news feed information for display on the web page.

13. The method according to claim 1 further comprising a sponsor portion for providing various sponsor-related information on the web page.

14. A method of providing a web-based academic social network web page comprising:
providing a digital academic profile portion configured to provide various academic information; and
providing a gallery portion having at least one of photographs or videos uploadable by a user,
wherein the academic information comprises at least one of statistics, school information, contact information, academic bio, academic information, news and events, athletic awards, and recommendations.

15. The method according to claim 14 further comprising an advertisement portion configured to provide advertisement-based content for display on the web page.

16. The method according to claim 14 further comprising an image portion allowing the display of uploaded images on the web page.

17. The method according to claim 14 further comprising a site menu providing various navigational controls to the web page.

18. The method according to claim 14 further comprising a text-based story portion providing at least one of story or images to the web page.

19. The method according to claim 1 further comprising an advertisement banner portion for providing banner-based advertisements to the web page.

20. The method according to claim 1 further comprising a chat portion for providing two-way chat communication to the web page.

21. The method according to claim 14 further comprising a contact portion for listing at least one of a name, role, email, telephone and other contact information to the web page.

22. The method according to claim 14 further comprising a discussion portion providing discussion capability through the web page.

23. The method according to claim 14 further comprising an events calendar portion providing events calendar capabilities on the web page.

24. The method according to claim 14 further comprising an announcement portion to provide various announcement information for display on the web page.

25. The method according to claim 14 further comprising a news feed portion for providing various news feed information for display on the web page.

26. The method according to claim 14 further comprising a sponsor portion for providing various sponsor-related information on the web page.

27. The method according to claim 1 further comprising a method and tools whereby users, businesses and others can rate content comprising at least one of news, photos, video, music, wherein the results of these ratings affect display, content pricing, and syndication, and the rating system also provides user behavior data.

28. The method according to claim 1 further comprising an ability to contribute content which is then eligible to be rated and consumed by other users and businesses.

29. The method according to claim 1 further comprising a method and tools to allow content ingestion and storage in a centralize repository.

30. The method according to claim 1 further comprising a method and tools to search content.

31. The method according to claim 1 further comprising a method and tools to select business rules that will define at least one of price points, target audience, revenue share percentage and copy rights contract.

32. The method according to claim 1 further comprising a method and tools for buyers of content to receive content through a syndication subscription model, rental model or purchase model

33. The method according to claim 1 further comprising a method and tools to automatically categorize content to be delivered to users and businesses utilizing an artificial intelligence engine, wherein the artificial intelligence engine learns from past behavior.

34. The method according to claim 1 further comprising a method and tools which allow peer reporting, which is a system whereby users, visitors and businesses can report inappropriate media, thereby removing questionable content.
